(19) United States
(12) Patent Application Publication
(10) Pub. No.: US 2009/0040540 A1
(43) Pub. Date: Feb. 12, 2009

(54) IMAGE PROCESSING APPARATUS AND METHOD OF CONTROLLING THE SAME

(75) Inventor: Hae Kee LEE, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/117,909

(22) Filed: May 9, 2008

(30) Foreign Application Priority Data
Aug. 8, 2007 (KR) 2007-79638

(51) Int. Cl. H04N 1/60

(52) U.S. Cl. 358/1.9

(57) ABSTRACT

The image processing apparatus includes a halftoning unit which performs halftoning with respect to a boundary pixel of an image data, and a setting unit which sets a window range and performs a resetting operation such that a print density of a portion of the boundary pixels in a window is transferred to another boundary pixel by using position information and density information of the boundary pixel.

### CROSS-REFERENCE TO RELATED APPLICATIONS

This application claims priority from Korean Patent Application No. 10-2007-0079638, filed on Aug. 8, 2007, in the Korean Intellectual Property Office, the disclosure of which is incorporated herein in its entirety by reference.

### BACKGROUND OF THE INVENTION

1. Field of the Invention

The present general inventive concept relates to an image processing apparatus and a method of controlling the same. More particularly, the present general inventive concept relates to an image processing apparatus capable of improving image quality at the boundary of an image and a method of controlling the same.

2. Description of the Related Art

Generally, an image processing apparatus (e.g., a laser printer, etc.) receives an image from a scanner, a host computer, etc., performs predetermined image processing with respect to the image, and then outputs the image onto a recording media, such as paper. Such an image processing apparatus performs halftoning in which a grayscale image having continuous tones or a color image is converted into a binary image in order to realize an image having various tones by using at least one toner or ink.

Meanwhile, a laser printer mainly performs the halftoning scheme by using a clustered dot screen and a dispersed dot screen. If the laser printer employs the clustered dot screen, an image transfer rate is increased as compared with that of the dispersed dot screen. However, the clustered dot screen may not reproduce the image in as much detail at a boundary area of an image, as compared with the dispersed dot screen.

Conventionally, in order to solve the above problem, an image is divided into a boundary area and a non-boundary area, and different halftoning schemes are performed according to the divided areas. For example, multilevel halftoning may be performed.

In this case, the multilevel halftoning refers to an expansion of bilevel or biltonal halftoning to create intermediate tones through a spatial conversion for at least two tones, which are black or white and at least one shade of gray. In order to perform such halftoning, a partial dot scheme and a full dot scheme are used. The partial dot scheme is used to print intermediate tones on all dots over the whole area and then to print intermediate tones having the next level, and the full dot scheme is used to sequentially print intermediate tones on each dot.

If the above dot schemes are used to perform the multilevel halftoning, as illustrated in FIG. 1, dots are smoothly linked with each other along the boundary of an image of “Quality.” In addition, it can be recognized from FIG. 2 that dots positioned at the boundary of an image of “n” are smoothly jointed to each other so that the boundary image is clearly expressed.

However, as illustrated in FIG. 3, when actually printing the image by using a laser printer, a bolded dot line abruptly appears along the boundary of a dark region. That is, the dots may not be smoothly linked with each other along the boundary, but the boundary of an image sporadically appears, which is called “jump phenomenon.”

### SUMMARY OF THE INVENTION

Additional aspects and/or utilities of the present general inventive concept will be set forth in part in the description that follows and, in part, will be apparent from the description, or may be learned by practice of the general inventive concept.

The present general inventive concept provides an image processing apparatus and a method of controlling the same.

The foregoing and/or other aspects and utilities of the present general inventive concept may be achieved by providing an image processing apparatus including a halftoning unit which performs halftoning with respect to a boundary pixel of an image data, and a setting unit which sets a window range and performs a resetting operation such that a print density of a portion of the boundary pixels in a window is transferred to another boundary pixel by using position information and density information of the boundary pixel.

The image processing apparatus may further include an input unit which receives the image data including a plurality of pixels and a detector which detects the boundary pixels of the image data.

The image processing apparatus may further include a storing unit which stores the position information of the boundary pixel.

The halftoning unit may perform multilevel halftoning with respect to the boundary pixel.

The halftoning unit may perform multilevel halftoning with respect to the boundary pixel by using a partial dot scheme.

The storing unit may store the density information of the boundary pixel that has been subject to halftoning.

The foregoing and/or other aspects and utilities of the present general inventive concept may be achieved by providing an image processing apparatus which includes a halftoning unit which performs halftoning with respect to a boundary pixel of image data according to colors, and a setting unit which sets a window range, and performs a resetting operation such that print density of the boundary pixels existing in a same position in a window and having at least two overlapped colors is transferred to a pixel having no print density, by using position information and density information of the boundary pixel.

The image processing apparatus may include an input unit which receives the image data including a plurality of pixels, and a detector which detects the boundary pixels of the image data.

The image processing apparatus may include a storing unit which stores the position information of the boundary pixel.

The halftoning unit may perform multilevel halftoning with respect to the boundary pixel, and, in more detail, may perform multilevel halftoning with respect to the boundary pixel by using a partial dot scheme.

The storing unit may store the density information of the boundary pixel that has been subject to halftoning.

The foregoing and/or other aspects and utilities of the present general inventive concept may be achieved by providing a method of controlling an image processing apparatus which includes detecting boundary pixels of an image data, performing halftoning with respect to the boundary pixels, setting a window range, and performing a resetting operation such that a print density of a portion of the boundary pixel in a window is transferred to another boundary pixel by using position information and density information of the boundary pixel.

The image data may be received with a plurality of pixels before the boundary pixels of the image data are detected.

The position information of the boundary pixel may be stored after the boundary pixel is detected.

The multilevel halftoning may be performed with respect to the boundary pixel by using a partial dot scheme when the boundary pixel is subject to halftoning.

The density information of the boundary pixel that has been subject to halftoning may be stored after the halftoning is performed with respect to the boundary pixel.

The foregoing and/or other aspects and utilities of the present general inventive concept may be achieved by providing a method of controlling an image processing apparatus which includes detecting boundary pixels of an image data, performing halftoning with respect to the boundary pixels according to colors, setting a window range, and performing a resetting operation such that a print density of the boundary pixels existing in a same position in a window having at least two overlapped colors is transferred to a pixel having no print density by using position information and density information of the boundary pixel according to colors.

The image data may be received with a plurality of pixels before the boundary pixels of the image data are detected.

The position information of the boundary pixel may be stored after the boundary pixel is detected.

The multilevel halftoning may be performed with respect to the boundary pixel by using a partial dot scheme when the boundary pixel is subject to halftoning.

The density information of the boundary pixel that has been subject to halftoning may be stored after the halftoning is performed with respect to the boundary pixel.

The foregoing and/or other aspects and utilities of the present general inventive concept may be achieved by providing an image processing apparatus which includes a setting unit which receives a first signal representing a halftoning with respect to a boundary pixel of an image data, transmits a second signal representing a window range, and transmits a third signal representing a resetting operation, wherein a portion of the boundary pixels in a window is transferred to another boundary pixel by using a fourth signal representing position information and density information of the boundary pixel.

The image processing apparatus may further include an input unit which receives the image data including a plurality of pixels and a detector which detects the boundary pixels of the image data.

The image processing apparatus may further include a storing unit which stores the fourth signal representing the position information of the boundary pixel.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a result of multilevel halftoning for an image of the word “Quality” using a partial dot scheme;

FIG. 2 is a view illustrating a result of multilevel halftoning for an image of the letter “n” by using a dot scheme;

FIG. 3 is a view illustrating an output result of a boundary area that has been subject to multilevel halftoning by using a partial dot scheme;

FIG. 4 is a block diagram illustrating an image processing apparatus according to an exemplary embodiment of the present general inventive concept;

FIG. 5 is a view illustrating image data that has been subject to halftoning by a halftoning unit illustrated in FIG. 4;

FIGS. 6A to 6D are views illustrating an operational procedure of resetting the image data of FIG. 5 such that the print density of a portion of boundary pixels is transferred to another boundary pixel;

FIG. 7 is a view illustrating image data reset by a setting unit of FIG. 4;

FIG. 8 is a view illustrating an output result of image data reset by a setting unit of FIG. 4;

FIG. 9 is a flowchart illustrating a control procedure of an image processing apparatus according to an exemplary embodiment of the present general inventive concept; and

FIG. 10 is a flowchart illustrating a control procedure of an image processing apparatus according to another exemplary embodiment of the present general inventive concept.

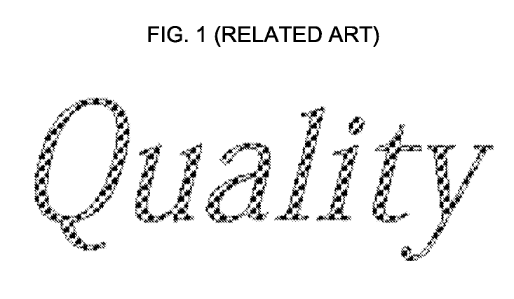

### DETAILED DESCRIPTION OF THE PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

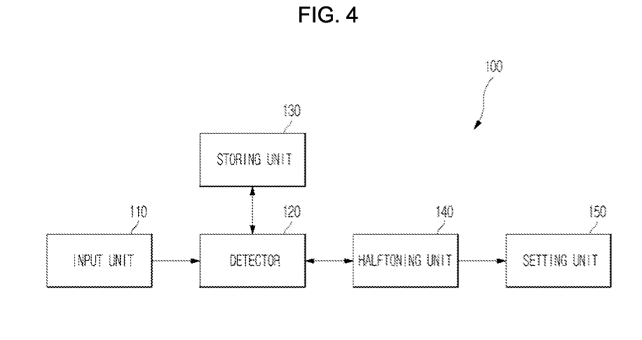

FIG. 4 is a block diagram illustrating an image processing apparatus according to an exemplary embodiment of the present general inventive concept. Referring to FIG. 4, an image processing apparatus 100 according to an exemplary embodiment includes an input unit 110, a detector 120, a storing unit 130, a halftoning unit 140, and a setting unit 150.

The input unit 110 receives image data including continuous tone digital images (e.g., picture, photograph, etc.) or text from an image providing apparatus (not shown) (e.g., scanner, digital camera, computer, etc.) However, the present general inventive concept is not limited thereto.

The detector 120 detects boundary pixels of the input image data received by the input unit 110.

The boundary pixels refer to pixels constituting an area having a high brightness ratio in the image data. In other words, when a brightness ratio is high between adjacent pixels, these pixels are referred to as boundary pixels.

Such detection of the boundary pixels refers to the detection of an edge or a contour. The edge is a line representing the border between areas in an image. As the difference between values, such as brightness values, of pixels forming the image becomes large, the border between the areas becomes clear. The above property is referred to as a discontinuity property.

Accordingly, if each pixel value is differentiated, discontinuity points can be easily detected. Through the above principle, an edge can be extracted from an image. Representative edge detection masks capable of detecting the edge of an image include a sobel mask, a prewitt mask, a Roberts mask, a laplacian mask, etc.

The storing unit 130 stores a position information of a boundary pixel detected from the detector 120.

The position information refers to coordinate information representing the position of the boundary pixel in the image data including a plurality of pixels. In an exemplary embodiment, the storing unit 130 stores position information expressed in the form of a matrix, such as (112, 129), and (14, 57).

Furthermore, the storing unit 130 stores density information of a boundary pixel.

In this case, the density information of the boundary pixel represents information about the print density of the boundary pixel that has undergone halftoning.

In more detail, if the boundary pixel is subject to multilevel halftoning, intermediate tones are created through spatial conversion of at least two tones, that is, a black or a white, and at least one shade of gray. For this reason, contrast information about each pixel tone, that is, contrast information about a dark area and a light area is divided into predetermined levels, so that density information can be expressed. For example, if the multilevel halftoning is performed by using a partial dot screen of 6×6×2 bit, a pixel can be expressed by 2 bits. Accordingly, the print density of a pixel can be expressed by four figures including 0 (white color), 1/3 (light gray color), 2/3 (dark gray color), and 1 (black color).

In an exemplary embodiment, the storing unit 130 includes a predetermined recoding media (e.g., DRAM, SDRAM, RDRAM, DDRAM, SRAM, etc.) that can store position information and density information of a boundary pixel. However, the present general inventive concept is not limited thereto.

The halftoning unit 140 performs a halftoning operation with respect to a boundary pixel detected from the detector 120.

In more detail, in an exemplary embodiment, the halftoning unit 140 performs a multilevel halftoning operation by using a partial dot scheme with respect to the boundary pixel. In addition, the halftoning unit 140 may perform bilevel halftoning, or multilevel halftoning by using a partial dot scheme, a full dot scheme, or a mixed scheme of the partial dot scheme and the full dot scheme with respect to an area except for a border of an image data. The halftoning unit 140 may perform halftoning by using various schemes as stated above in addition to other schemes.

In summary, the halftoning unit 140, which performs halftoning for each pixel of input image data, determines whether the pixel is a boundary pixel by using position information of the boundary pixel stored in the storing unit 130. Then, the halftoning unit 140 performs multilevel halftoning with respect to a pixel determined as the boundary pixel, and performs halftoning with respect to a pixel that is not the boundary pixel by using various schemes.

If image data corresponds to a color image, the image data are expressed by red, green, and blue data (R, G and B). In order to output the image data to the image processing apparatus, the R, G and B data are converted into cyan, magenta, yellow, and black data (C, M, Y, and K) that are print colors, and the halftoning unit 140 performs halftoning with respect to a boundary pixel according to colors (C, M, Y, and K).

In other words, the halftoning unit 140 performs halftoning with respect to a boundary pixel according to cyan, magenta, yellow, and black colors (C, M, Y, and K).

The setting unit 150 sets a window range of the input image data.

In other words, the setting unit 150 sets a dot range, that is, a criterion window range with respect to image data including a plurality of pixels. For example, when a window range is set using 2×2 pixels, a 2×2 window may be set as the window range. Such a window may be formed within various window ranges according to the structure and function of the image processing apparatus 100 or the number of pixels. In an exemplary embodiment, the setting unit 150 may have previously set a window range and may store the window range in the storing unit 130.

The setting unit 150 performs a resetting operation to transfer the print density of a portion of boundary pixels in a window to another boundary pixel by using the position information and the density information of the boundary pixels stored in the storing unit 130.

In other words, the setting unit 150 sets a window range that is a criterion of transferring the print density of a portion of boundary pixels to another boundary pixel, and determines the boundary pixel within the set window range to perform a control operation such that the print density of the boundary pixel is transferred to another boundary pixel.

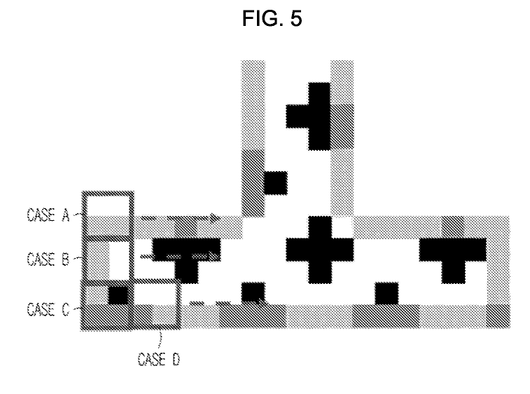

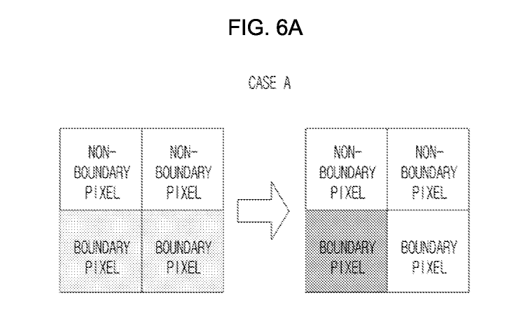

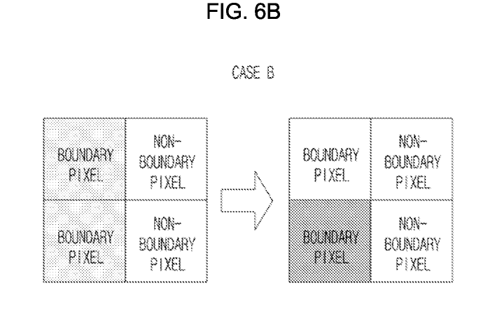

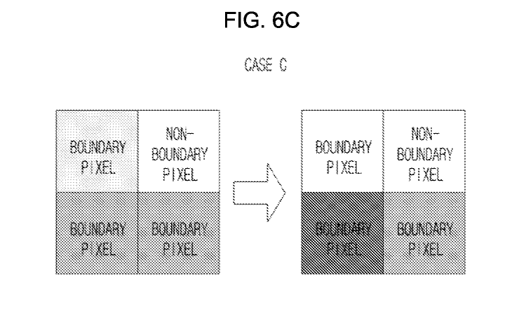

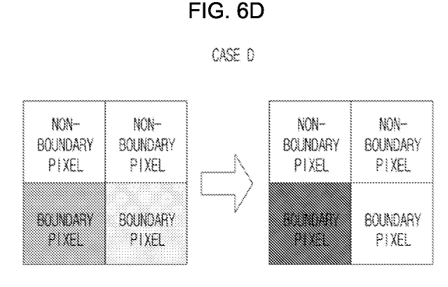

FIG. 5 is a view illustrating image data that has been subject to halftoning by the halftoning unit 140 illustrated in FIG. 4, and FIGS. 6A to 6D are views illustrating an operational procedure of resetting the image data of FIG. 5 such that the print density of a portion of boundary pixels is transferred to another boundary pixel. In FIG. 5, and FIGS. 6A to 6D, it is assumed that a window range is set as a 2×2 window, and a boundary pixel has been subject to multilevel halftoning by using a 6×6×2 bit partial dot scheme. However, the present general inventive concept is not limited thereto.

Referring to FIGS. 5 and 6A, the setting unit 150 determines, by using the position information of a boundary pixel stored in the storing unit 130, that two upper pixels are not boundary pixels, and two lower pixels are boundary pixels in a window of case A.

In addition, it can be recognized by using the print density of a boundary pixel stored in the storing unit 130 that two lower pixels have print densities of 1/3 and 1/3. Accordingly, the print density of one boundary pixel positioned in the lower right side is transferred to the other boundary pixel position in the lower left side so that the boundary pixel positioned in the lower left side has the print density of 2/3.

Referring now to FIGS. 5 and 6B, since each boundary pixel positioned in the left side has a print density of 1/3 in a window of case B, the setting unit 150 transfers the print density of the boundary pixel positioned in the upper left side to the boundary pixel positioned in the lower left side, so that the boundary pixel of the lower left side has the print density of 2/3.

Referring now to FIGS. 5 and 6C, since the setting unit 150 determines that three boundary pixels exist in a window of case C, except for a boundary pixel positioned in the upper right side, the setting unit 150 transfers the print density of 1/3 of a boundary pixel positioned in the upper left side to a boundary pixel having the print density of 2/3 in the lower left side so that the boundary pixel positioned in the lower left side can be reset as a boundary pixel having the print density of 1.

As illustrated in FIGS. 5 and 6D, since the setting unit 150 can determine that two lower boundary pixels having print densities of 2/3 and 1/3 exist in a window of case D, the setting unit 150 transfers the print density of a boundary pixel, which is positioned in a lower right side, to a boundary pixel, which is positioned in a lower left side, in two boundary pixels so that the boundary pixel in the lower left side can be reset as a boundary pixel having the print density of 1.

Meanwhile, according to the present general inventive concept, although the boundary pixels are divided into upper, lower, left, and right boundary pixels, a predetermined structure of the boundary pixels may be employed without the above division if the print density of a portion of boundary pixels can be transferred to another boundary pixel in the structure.

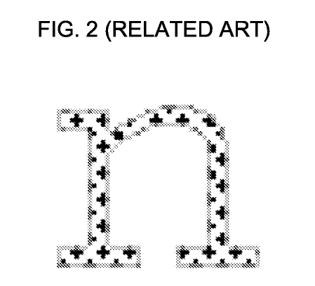

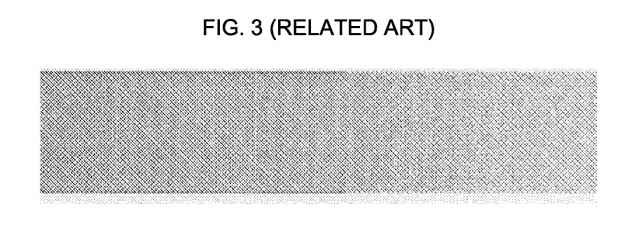

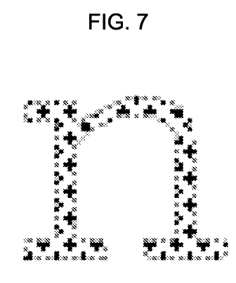

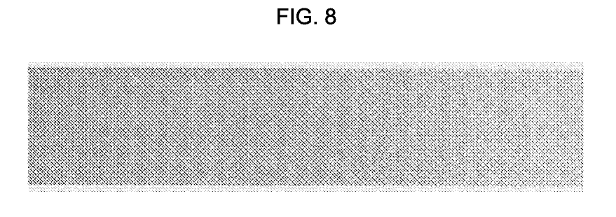

FIG. 7 is a view illustrating an image data reset by the setting unit 150 of FIG. 4, and FIG. 8 is a view illustrating an output result of image data reset by the setting unit 150 of FIG. 4. When comparing image data including boundary pixels reset by the setting unit 150 with image data of FIG. 2, it can be recognized from FIG. 7 that the print density of a portion of boundary pixels is transferred on another boundary pixel. If the image data illustrated in FIG. 7 are output, as illustrated in FIG. 8, a boundary is smoothly expressed.

In an exemplary embodiment, the setting unit 150 moves the print density of boundary pixels existing in the same position of a window and having at least two overlap colors to a pixel having no print density by using a position information and a density information of the boundary pixel according to colors.

In other words, the setting unit 150 moves the print density of boundary pixels existing in the same position of the window and having at least two overlap colors to a pixel having the print density of 0, that is, a pixel having no dot printed thereon by using the position information and the density information of the boundary pixel according to colors, which have been previously stored in the storing unit 130.

For example, when a window range is 2×2, a boundary pixel, which has print density of 1 with respect to cyan, exists in the position of (1,1) of the window, and a boundary pixel, which has print density of 1 with respect to magenta, exists at a position of (1,1) of the window, the print density of the boundary pixel for cyan is identical to the print density of the boundary pixel for magenta, so that the setting unit 150 moves the print density of the boundary pixel for the cyan or the magenta to one of pixels having no print density positioned in (1,2), (2,1), and (2,2).

Hereinafter, a method of controlling an image processing apparatus according to an embodiment of the present general inventive concept will be described.

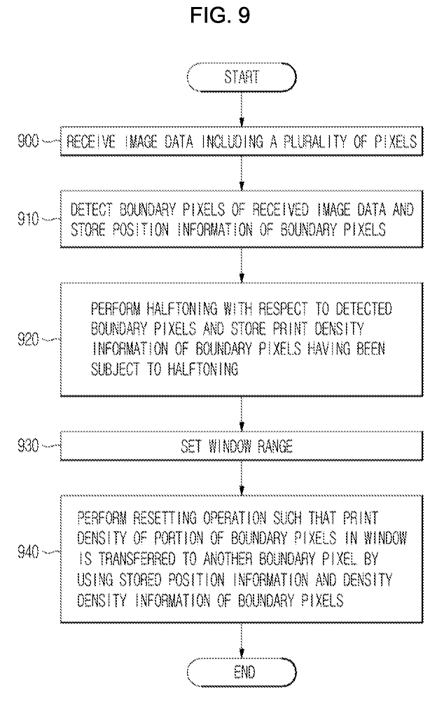

FIG. 9 is a flowchart illustrating a control procedure of the image processing apparatus according to an exemplary embodiment of the present general inventive concept. As illustrated in FIG. 9, the input unit 110 receives image data including a plurality of pixels (operation 900).

The detector 120 detects boundary pixels of the input image data, and the storing unit 130 stores position information about the detected boundary pixel (operation 910).

Then, the halftoning unit 140 performs halftoning with respect to the detected boundary pixels, and the storing unit 130 stores density information of a boundary pixel that has been subject to halftoning (operation 920).

In the current exemplary embodiment, the halftoning unit 140 performs multilevel halftoning with respect to the boundary pixels, and performs bilevel halftoning or multilevel halftoning with respect to pixels that are not boundary pixels. However, the present general inventive concept is not limited thereto. After the above halftoning is performed, the density information of the boundary pixel is stored in the storing unit 130.

Then, the setting unit 150 sets the window range (operation 930), and performs a resetting operation such that the print density of a portion of the boundary pixels in a window is transferred on another boundary pixel by using the position information and the density information of the boundary pixels stored in the storing unit 130 (operation 940).

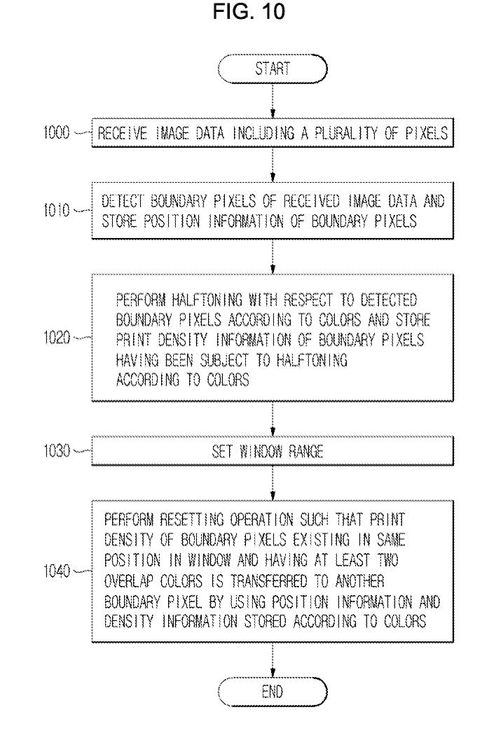

FIG. 10 is a flowchart illustrating a control operation of the image processing apparatus according to another exemplary embodiment of the present general inventive concept. As illustrated in FIG. 10, the input unit 110 receives image data including a plurality of pixels (operation 1000).

The detector 120 detects boundary pixels of the input image data, and the storing unit 130 stores the position information of the detected boundary pixel (operation 1010).

Then, the halftoning unit 140 performs halftoning with respect to the detected boundary pixels according to colors, and the storing unit 130 stores the density information of the boundary pixels, which have been subject to halftoning, according to colors (operation 1020).

In this case, the halftoning unit 140 performs multilevel halftoning with respect to boundary pixels, and performs bilevel halftoning or multilevel halftoning with respect to pixels that are not boundary pixels. After the above halftoning is performed, the storing unit 130 stores the density information of the boundary pixels.

Next, the setting unit 150 sets a window range (operation 1030), and moves the print density of the boundary pixels existing in the same position of a window and having at least two overlap colors to a pixel having no print density (operation 1040).

As described above, in an image processing apparatus and a method of controlling the same according to the present general inventive concept, a resetting operation is performed such that the print density of a portion of boundary pixels having been subject to halftoning is transferred to another boundary pixel, and the print density of the boundary pixels having at least two overlap colors is transferred to a pixel having no print density, thereby smoothly expressing a boundary area to realize an image when image data are actually printed out.

In addition, the above image quality improvement can enhance printing quality of an image.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although few embodiments of the present general inventive concept have been shown and described, it would be appreciated by those skilled in the art that changes may be made in these exemplary embodiments without departing from the principles and spirit of the general inventive concept, the scope of which is defined in the claims and their equivalents.

What is claimed is:

1. An image processing apparatus comprising:
a halftoning unit which performs halftoning with respect to a boundary pixel of an image data; and
a setting unit which sets a window range and performs a resetting operation such that a print density of a portion of boundary pixels in a window is transferred to another boundary pixel by using position information and density information of the boundary pixel.

2. The image processing apparatus as claimed in claim 1, further comprising:
an input unit which receives the image data including a plurality of pixels; and
a detector which detects the boundary pixels of the image data.

3. The image processing apparatus as claimed in claim 2, further comprising:
a storing unit which stores the position information of the boundary pixel.

4. The image processing apparatus as claimed in claim 1, wherein the halftoning unit performs multilevel halftoning with respect to the boundary pixel.

5. The image processing apparatus as claimed in claim 4, wherein the halftoning unit performs multilevel halftoning with respect to the boundary pixel by using a partial dot scheme.

6. The image processing apparatus as claimed in claim 3, wherein the storing unit stores the density information of the boundary pixel that has been subject to halftoning.

7. An image processing apparatus comprising:
a halftoning unit which performs halftoning with respect to a boundary pixel of an image data according to colors; and
a setting unit which sets a window range, and performs a resetting operation such that a print density of the boundary pixels existing in a same position in a window and having at least two overlapped colors is transferred to a pixel having no print density, by using position information and density information of the boundary pixel.

8. The image processing apparatus as claimed in claim 7, further comprising:
an input unit which receives the image data including a plurality of pixels; and
a detector which detects the boundary pixels of the image data.

9. The image processing apparatus as claimed in claim 8, further comprising a storing unit which stores the position information of the boundary pixel.

10. The image processing apparatus as claimed in claim 7, wherein the halftoning unit performs multilevel halftoning with respect to the boundary pixel.

11. The image processing apparatus as claimed in claim 10, wherein the halftoning unit performs multilevel halftoning with respect to the boundary pixel by using a partial dot scheme.

12. The image processing apparatus as claimed in claim 9, wherein the storing unit stores the density information of the boundary pixel that has been subject to halftoning.

13. A method of controlling an image processing apparatus, the method comprising:
detecting boundary pixels of an image data;
performing halftoning with respect to the boundary pixels;
setting a window range; and
performing a resetting operation such that a print density of a portion of the boundary pixel in a window is transferred to another boundary pixel by using position information and density information of the boundary pixel.

14. The method as claimed in claim 13, wherein the image data is received with a plurality of pixels before the boundary pixels of the image data are detected.

15. The method as claimed in claim 14, wherein the position information of the boundary pixel is stored after the boundary pixel is detected.

16. The method as claimed in claim 13, wherein multilevel halftoning is performed with respect to the boundary pixel by using a partial dot scheme when the boundary pixel is subject to halftoning.

17. The method as claimed in claim 13, wherein the density information of the boundary pixel that has been subject to halftoning is stored after the halftoning is performed with respect to the boundary pixel.

18. A method of controlling an image processing apparatus, the method comprising:
detecting boundary pixels of an image data;
performing halftoning with respect to the boundary pixels according to colors;
setting a window range; and
performing a resetting operation such that a print density of the boundary pixels existing in a same position in a window having at least two overlapped colors is transferred to a pixel having no print density by using position information and density information of the boundary pixel according to colors.

19. The method as claimed in claim 18, wherein the image data are received with a plurality of pixels before the boundary pixels of the image data are detected.

20. The method as claimed in claim 19, wherein the position information of the boundary pixel is stored after the boundary pixel is detected.

21. The method as claimed in claim 18, wherein multilevel halftoning is performed with respect to the boundary pixel by using a partial dot scheme when the boundary pixel is subject to halftoning.

22. The method as claimed in claim 18, wherein the density information of the boundary pixel that has been subject to halftoning is stored after the halftoning is performed with respect to the boundary pixel.

23. An image processing apparatus, comprising:
a setting unit which receives a first signal representing a halftoning with respect to a boundary pixel of an image data, transmits a second signal representing a window range, and transmits a third signal representing a resetting operation,
wherein a portion of the boundary pixels in a window is transferred to another boundary pixel by using a fourth signal representing position information and density information of the boundary pixel.

24. The image processing apparatus as claimed in claim 23, further comprising:
an input unit which receives the image data including a plurality of pixels; and
a detector which detects the boundary pixels of the image data.

25. The image processing apparatus as claimed in claim 24, further comprising a storing unit which stores the fourth signal representing the position information of the boundary pixel.
